(19) United States
(12) Patent Application Publication
(10) Pub. No.: US 2017/0103100 A1
(43) Pub. Date: Apr. 13, 2017

(54) SYSTEM FOR MULTIDIMENSIONAL DATABASE ADMINISTRATION

(71) Applicant: BANK OF AMERICA CORPORATION, Charlotte, NC (US)

(72) Inventors: Anant Bondalapati Sharma, Hyderabad (IN); Kodanda Rama Krishna Neti, Hyderabad (IN); Badelal Rameshwar Prasad Yadav, Mumbai (IN)

(21) Appl. No.: 14/881,623

(22) Filed: Oct. 13, 2015

(51) Int. Cl. G06F 17/30; G06F 11/14; H04L 29/08

(52) U.S. Cl. CPC G06F 17/30371; H04L 67/10; G06F 17/30477; G06F 11/1448; G06F 2201/80

(57) ABSTRACT

The present invention provides for multidimensional automated database administration, such that, multiple database scripts can be deployed and executed across multiple database servers and the multiple databases stored therein. In addition, the present invention manages the sequence/order in which the scripts are automatically deployed/executed and provides for automated tracking of execution results including error tracking on a per script basis. Additionally, the invention can be deployed in a distributed network allowing for cross domain connectivity to the database servers for the purpose of executing the database scripts without requiring deployment of server-side script deployment agents.

### FIELD

In general, embodiments of the invention relate database administration and, more specifically, multidimensional database administration including execution of multiple scripts on multiple databases on multiple database servers.

### BACKGROUND

Conventionally, database script processing is a predominately manual process, in which users, commonly referred to as database administrators, are tasked with executing a large volume of database script files on multiple database servers and multiple databases within the database servers. Such manual processing becomes a daunting task when an enterprise requires consistent deployment/execution of the large volume of database script files (e.g., 150-200 database scripts or the like) across multiple database servers and databases. Additionally, manual processing may include a labor-intensive validation of the scripts to insure that scripts do not include syntactical errors or non-approved commands within the database scripts.

In this regard, manual processing is prone to human error, such as, but not limited to, inadvertently missing the deployment/execution of a script, incorrectly ordering/sequencing execution scripts (resulting in what is referred to as a sequence breach) and the like. Further, sequencing/ordering may be dependent on the database server and/or database on which the scripts are being executed.

Additionally, known database administration processes do not provide for logging or otherwise maintaining execution results for the purpose of tracking results, providing a requisite audit trail or the like.

Therefore, a need exists to develop systems, apparatus, computer program products, methods and the like that provide an automated approach to database administration and, specifically deployment/execution of database scripts. The desired invention should provide for multiple database scripts to be automatically executed simultaneously across multiple database servers and multiple databases within the multiple database servers. In this regard, the desired invention should demand minimal manual effort on the part of database administrators. In addition, the desired invention should not require reconfiguration or execution of software/agents on the database server-side, but rather function centrally in a distributed network in which the system has the ability to connect to any databased server for the purpose of deploying/executing requisite database scripts (i.e., no hosting infrastructure should be required). Moreover, the desired invention should provide for error-free execution of scripts and for automated tracking of execution, such that, deployment/executions along with resulting errors are logged for audit purposes and the like.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, computer program products, methods or the like for multidimensional database administration whereby multiple database scripts can be deployed and executed on multiple database servers and multiple databases stored on such servers. Systems of the present invention can be implemented in a distributed computing network, such that the invention provides for centralized connectivity across various different domains to database servers for the purpose of deploying/executing the database scripts. As such, the present invention requires no hosting infrastructure nor deployment of any server-side agents or configuration.

In addition to deployment/execution of scripts, the present invention provides management over the sequence/ordering of scripts to thereby insure that the execution of multiple scripts on a database occur in the proper order. In addition, the present invention provides for comprehensive tracking and auditable logging of database script execution including, but not limited to, execution results including error tracking on a per database script basis, time tracking of execution, and the like. Moreover, the tracking and logging capabilities provide for multiple diagnostic reports to run on a per-database script, per-database server or per-database or combination thereof basis.

As such the present invention eliminates the need to perform manual deployment/execution of multiple scripts in a multiple database server environment. Thus, the present invention lessens the likelihood, if not eliminates the possibility of human errors occurring, such as failing to execute a required script, breach of sequence/ordering requirements or the like. Moreover, the tracking of script execution results and logging allow for execution errors to be properly investigated and corrective actions taken to prevent similar future errors.

A system for automated administration of databases provides for first embodiments of the invention. The system includes a plurality of database servers, each database server storing one or more databases. The databases may exist across multiple different domains within a distributed computer network environment, such that the system can centrally connect to any of the plurality of servers for the purpose of deploying/executing database scripts.

The system additionally includes a computing platform having a memory and at least processor in communication with the memory. The memory stores a database administration module that is executable by the processor. The database administration module is accessible to a user within a distributed network and configured to receive a first user-selection of one or more database scripts, receive a second user-selection of one or more of the database servers on which the selected one or more database scripts are to be deployed, and receive a third user-selection of one or more databases stored in the one or more selected database servers on which the selected one or more database scripts are to be executed. Further, in response to receiving the first, second and third user-selections, the database administration module automatically connects to the selected databases servers to execute the selected one or more database scripts on the selected databases. Moreover, the database administration module is configured to execute the database scripts absent a database server-side script deployment agent or reconfiguration of the database server.

In accordance with specific embodiments of the system the database administration module is configured to automatically validate a plurality of database scripts prior to execution of the database scripts. Validation of the database scripts includes checking for syntactical errors and non-approved commands within the database scripts for each of the plurality of databases servers and for each of the databases stored on the database servers. In such embodiments of the system, the database administration module is configured to, in response to the validation resulting in failure of one or more database scripts, automatically generate a report that includes one or more non-approved commands within the one or more scripts that failed validation.

In further specific embodiments of the system the database administration module is configured to automatically validate one or more database backups prior to execution of the database scripts, wherein validation of the database backups includes checking the integrity of the database backup file and generating a corresponding report.

In still further specific embodiments of the system the database administration module further includes a sequence manager configured to automatically manage database script deployment sequence for more than one database script. In such embodiments, computer-script deployment sequence is dependent on at least one of the database server and the database on which the more than one database script is to be executed.

In additional embodiments of the system the database administration module is configured to receive a fourth user-selection, prior to executing the one or more database scripts, that provides for one of (1) execution of the computing scripts to be interrupted in response to detection of an error, or (2) execution of the computing scripts to be uninterrupted in response to detection of an error.

Moreover, in additional embodiments of the system the database administration module is further configured to automatically track the execution of the selected one or more database scripts on the selected databases of the selected database servers, wherein tracking the execution includes logging (1) the database servers on which the one or more database scripts are executed, (2) the databases on which the one or more database scripts are executed, and (3) sequence in which the one or more database scripts are executed. In additional embodiments of the system, tracking the execution of the database scripts includes identifying database scripts that executed successfully, identifying database scripts that failed to execute successfully and identifying errors occurring on database scripts that failed to execute successfully.

In still further embodiments of the system the database administration module is configured to, in response completion of the execution of the selected one or more database scripts, generate a report that includes one or more of (i) results of the execution of the selected one or more database scripts, (ii) failure causes for each database script that failed to execute successfully, (iii) segmentation of errors occurring on each database script, and (iv) time of execution for each of the computing scripts.

A computer-implemented method for database administration defines second embodiments of the invention. The method includes receiving a first user-selection of one or more database scripts and receiving a second user-selection of one or more of the database servers on which the selected one or more database scripts are to be deployed. The method further includes receiving a third user-selection of one or more databases stored in the one or more selected database servers on which the selected one or more database scripts are to be executed. Additionally, the method includes, in response to receiving the first, second and third user-selections, automatically connecting to the selected database servers to execute the selected one or more database scripts on the selected databases. Further, according to the method, the database scripts are configured to execute absent a server-side script deployment agent and/or reconfiguration of the database servers.

In specific embodiments the method includes automatically validating a plurality of database scripts prior to execution of the database scripts. Validation of the database scripts includes checking for (i) syntactical errors and (ii) non-approved commands within the database scripts for each of the plurality of databases servers and for each of the databases stored on the database servers. In other specific embodiments the method includes to automatically validating, one or more database backups prior to execution of the database scripts on the databases. Validation of the database backups includes checking the integrity of the database backup files prior to executing the scripts.

In further specific embodiments the method includes automatically managing database script deployment sequence for more than one database script. In such embodiments computer-script deployment sequence is dependent on at least one of the database server and the database on which the more than one database script is to be executed.

In further embodiments the method includes automatically tracking the execution of the selected one or more database scripts on the selected databases of the selected database servers. In such embodiments tracking the execution may include logging (1) the database servers on which the one or more database scripts are executed, (2) the databases on which the one or more database scripts are executed, and (3) sequence in which the one or more database scripts are executed. In other embodiments of the method tracking may include identifying database scripts that executed successfully, identifying database scripts that failed to execute successfully and identifying errors occurring on database scripts that failed to execute successfully.

In yet other embodiments the method includes, in response completion of the execution of the selected one or more database scripts, generating, by a computing device processor, a report that includes one or more of (i) results of the execution of the selected one or more database scripts, (ii) failure causes for each database script that failed to execute successfully, (iii) segmentation of errors occurring on each database script, and (iv) time of execution for each of the computing scripts.

A computer program product including a non-transitory computer-readable medium defines third embodiments of the invention. The computer-readable medium includes a first set of codes for causing a computer to receive a first user-selection of one or more database scripts, a second user-selection of one or more of the database servers on which the selected one or more database scripts are to be deployed and a third user-selection of one or more databases stored in the one or more selected database servers on which the selected one or more database scripts are to be executed. The computer-readable medium additionally includes a second set of codes for causing a computer to, in response to receiving the first, second and third user-selections, automatically connect to the selected database servers to execute the selected one or more database scripts on the selected databases. The database scripts are configured to execute absent a server-side script deployment agent.

Thus, systems, apparatus, methods, and computer program products herein described in detail below provide for multidimensional automated database administration, such that, multiple database scripts can be deployed and executed across multiple database servers and the multiple databases stored therein. In addition, the present invention manages the sequence/order in which the scripts are automatically deployed/executed and provides for automated tracking of execution results including error tracking on a per script basis. Additionally, the invention herein described in detail below is deployed in a distributed network allowing for cross domain connectivity to the database servers for the purpose of executing the database scripts without requiring deployment of server-side script deployment agents or reconfiguration of the database servers.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram for multidimensional database administration, in accordance with embodiments of the present invention;

FIG. 2 provides a block diagram is a database administration apparatus for automatically executing multiple scripts on multiple databases stored within multiple database servers, in accordance with embodiments of the present invention;

FIG. 3 provides a flow diagram of a method for multidimensional database administration, in accordance with embodiments of the present invention;

FIG. 4 provides a flow diagram of a method for multidimensional database administration, in accordance with embodiments of the invention; and

FIG. 5 provides a flow diagram of a method for multidimensional database administration, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for multidimensional database administration whereby multiple database scripts can be deployed and executed on multiple database servers and multiple databases stored on such servers. Systems of the present invention can be implemented in a distributed computing network, such that the invention provides for centralized connectivity across various different domains to database servers for the purpose of deploying/executing the database scripts. As such, the present invention requires no hosting infrastructure nor deployment of any server-side agents or reconfiguration of the database servers.

In addition to deployment/execution of scripts, the present invention validation of the scripts prior to deployment/execution as a means of checking for syntactical errors and non-approved commands within the scripts. Additionally, the present invention provides management over the sequence/ordering of scripts to thereby insure that the execution of multiple scripts on a database occur in the proper order. In addition, the present invention provides for comprehensive tracking and auditable logging of database script execution including, but not limited to, execution results including error tracking on a per database script basis, time tracking of execution, and the like. Moreover, the tracking and logging capabilities provide for multiple diagnostic reports to be run on a per-database script, per-database server or per-database or combination thereof basis.

As such the present invention eliminates the need to perform manual deployment/execution of multiple scripts in a multiple database server environment. Thus, the present invention lessens the likelihood, if not eliminates the possibility, of human errors occurring, such as failing to execute a required script, breach of sequence/ordering requirements or the like. Moreover, the tracking of script execution results and logging allows for an auditable execution of database scripts, such that, execution errors may be properly investigated and corrective actions taken to prevent similar future errors.

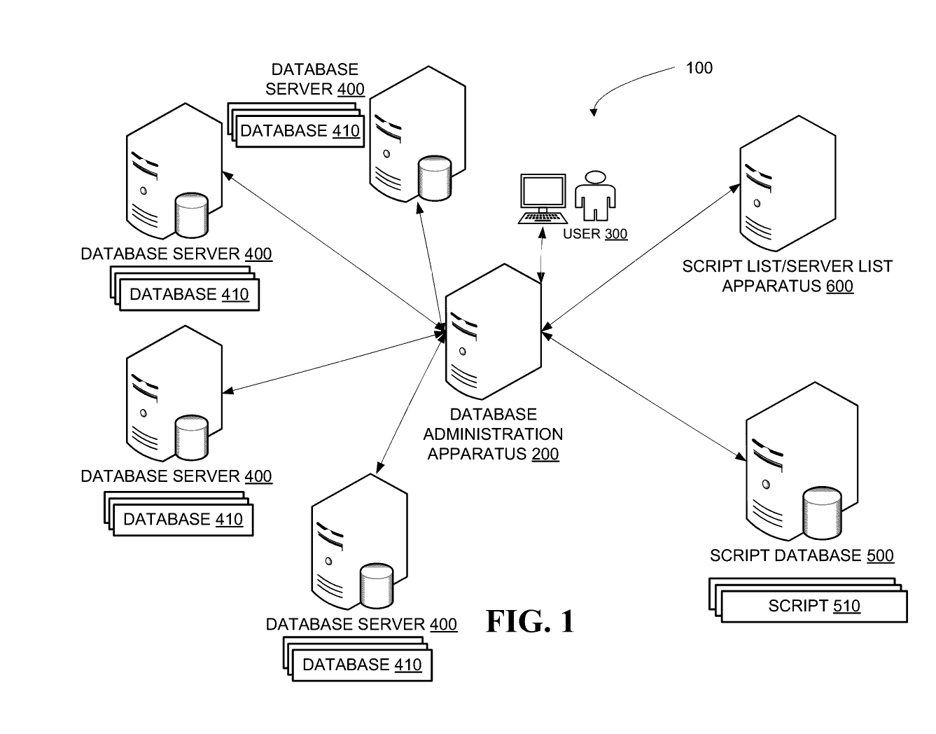

Referring to FIG. 1 a schematic diagram is provided of a system 100 for multidimensional database administration, according to embodiments of the present invention. The system includes a database administration apparatus 200 that is in networked communication with user 300 (via a user computing device) and is configured to allow the user 300, through a Graphical User-Interface (GUI) application, to deploy/execute multiple database scripts on multiple database servers and multiple databases within the database servers. As such, database administration apparatus 200 is in communication with script list/server list apparatus 600 which provides the user a listing of available database scripts and a listing of database servers requiring script updates. The user, through the GUI application, selects which database scripts to execute on which database servers and which databases within the database servers. Database administration apparatus 200 is in further network communication with script database 500 that stores the plurality of database scripts 510. In response to user selection of the database scripts, database servers and databases, the database administration apparatus 200 accesses the script database 500 to retrieve the selected scripts 510 and connects with the selected database servers 400 to execute the scripts on the selected databases 410 within the selected database servers 400.

As shown in FIG. 1, the system 100 is implemented in a distributed network, such that the database administration apparatus 200 has cross domain connectivity to database servers 400 residing in different domains. Additionally, since no hosting infrastructure is required, the system 100 does not require deployment/installation of any database server-side agents or software nor reconfiguration of the database servers or databases.

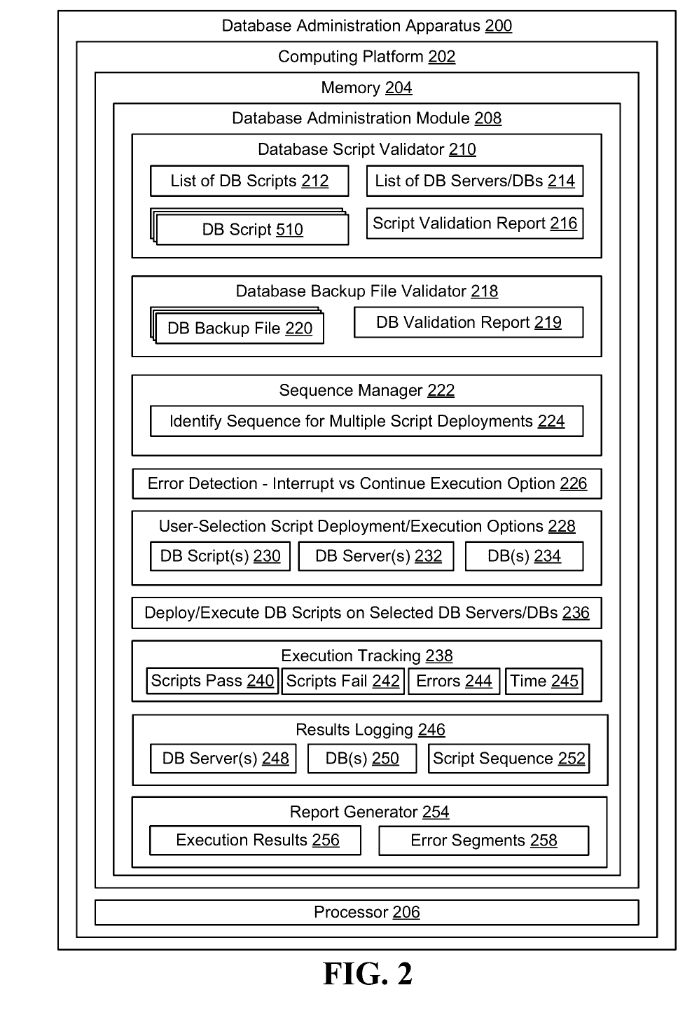

Referring to FIG. 2, a block diagram is provided of data administration apparatus 200, in accordance with embodiments of the present invention. The apparatus 200 may comprise one or more computing devices, such as multiple servers, routers and the like. The apparatus 200 includes a computing platform 202 which a memory 204 and at least one processor 206 in communication with the memory 14. Computing platform 202 can receive and execute algorithms, such as modules, routines, and applications.

Memory 204 may comprise volatile and non-volatile memory, such as read-only and/or random-access memory (RAM and ROM), EPROM, EEPROM, flash cards, or any memory common to computer platforms. Further, memory 204 may include one or more flash memory cells, or may be any secondary or tertiary storage device, such as magnetic media, optical media, tape, or soft or hard disk. Moreover, memory 204 may comprise cloud storage, such as provided by a cloud storage service and/or a cloud connection service.

Further, processor 216 may be an application-specific integrated circuit (“ASIC”), or other chipset, processor, logic circuit, or other data processing device. Processor 216 or other processor such as ASIC may execute an application programming interface (“API”) (not shown in FIG. 2) that interfaces with any resident programs or modules, such as database administration module 208 and routines, sub-modules associated therewith or the like stored in the memory 204 of computing platform 202.

Processor 206 includes various processing subsystems (not shown in FIG. 2) embodied in hardware, firmware, software, and combinations thereof, that enable the functionality of database administration apparatus 200 and the operability of the system on a network. For example, processing subsystems allow for initiating and maintaining communications and exchanging data with other networked computing platforms, such as script list/server list apparatus 600, script database 500 and database servers 400 (all of which are shown in FIG. 1). For the disclosed aspects, processing subsystems of processor 206 may include any subsystem used in conjunction with database administration module 208 and related algorithms, sub-algorithms, modules, sub-modules thereof.

Computer platform 202 may additionally include a communications module (not shown in FIG. 2) embodied in hardware, firmware, software, and combinations thereof, that enables communications among the various components of the computing platform 202, as well as between the other networked devices. Thus, communication module may include the requisite hardware, firmware, software and/or combinations thereof for establishing and maintaining a network communication connections with the script database 500 and the database servers 400 (shown in FIG. 1).

Memory 204 of computing platform 202 stores database administration module 208 that is executable by processor 206 and configured to provide for multidimensional database administration in the form of deploying/executing multiple scripts on multiple database servers and multiple databases within the database servers, in accordance with embodiments of the present invention.

In specific embodiments of the invention, database administration module 208 includes database script validator 210 that is configured to validate database scripts 510 prior to deployment/execution of the scripts 510. As such, database script validator 210 is configured to receive a list of database scripts 212 to be deployed/executed, as well as, a list of database servers and/or databases 214 requiring script deployment. In response to receiving the lists 212 and 214 and receiving an input from an administrator/user, the database script validator 210 performs validation of all of the database scripts 510 for non-approved commands and, in some embodiments, syntactical errors. Identifying non-approved commands takes into account that possible malicious or otherwise harmful command/code may have intentional or unintentionally been added to a script. In response to the validation resulting in one or more failures (i.e., one or more non-approved commands found in the database scripts, database validator 210 generates and initiates communication of a validation report 216 to predetermined entities within the enterprise. In response to the entities receiving the report, a decision is made as whether the non-approved commands can be authorized for execution or whether corrective action is required (i.e., script update/revision) prior to executing the database scripts 510. Moreover, the invention provides for dynamically configurable non-approved command/exclusion list, which can be updated by an administrator/user on-the-fly. Validation of the database scripts prior to execution insures that the results of the deployment/execution are audit-proof.

Additionally, in other specific embodiments of the invention, the database administration module 208 includes database backup file validator 218 that is configured to validate the existence and/or integrity of a last-in-time database backup files 220 prior to deploying/executing the database scripts 510. In the event that the database backup file validation results in a failure (i.e., a database backup file is determined to be corrupt or the like), the database backup file validator 218 may, in certain embodiments, generate and initiate communication of a database backup validation report 219 to predetermined entities within the enterprise.

In additional embodiments of the invention, the database administration module 208 includes a sequence manager 224 that is configured to, if required, determine/identify the sequence 224 (otherwise referred to as order or arrangement) for multiple script execution. Scripts are developed with a specific order required. The order sequence may be based on the combination of scripts, the database server the scripts are being deployed on, the databases the scripts are being executed on or any combination thereof. As such, sequence manager 224 may be implemented prior to after user selection of the scripts, the database servers and the databases. Automated determination/identification of the script sequence 224 eliminates the possibility of sequence breaches occurring, which are common if script deployment/execution occurs manually.

Additionally, in other embodiments of the invention, the database administration module 208 includes an error detection interrupt/continue option 226 that is configured to allow the administrator/user, prior to deploying/executing the database scripts 510, to choose between allowing the script execution process to continue in response to detection of any errors in the execution process or interrupting (i.e., stopping) the execution process upon each occurrence of an error in the execution process.

As previously described, according to embodiments of the invention, the database administration module 208 includes user-selection script deployment/execution options 228. The options 228 include, but are not necessarily limited to, a database script option 230 in which the administrator/user selects which of database scripts 510 to deploy/execute, a database server option 232 in which the administrator/user selects which of database server(s) 400 to deploy/execute the selected scripts 510 on, and a database option 234 in which are the administrator/user selects which database configured to allow the administrator/user to select which database(s) 410 on the selected database server(s) 400 to execute the selected database scripts 510 on. In response to selecting the database scripts 510, database server(s) 400 and database(s) 410, the user will provide an input that is configured to automatically connect to the selected database server(s) 400 to initiate deployment/execution 236 of the scripts 510 on the databases 410.

In addition, according to other embodiments of the invention, the database administration module 208 includes execution tracking 238 that is configured to provide the administrator/user with immediate feedback of the database script execution process, including, but not limited to, scripts that have passed 240 execution, scripts that have failed 242 execution, the errors 244 associated with a failed script and the execution time 245 (i.e., a running clock of a current execution, and/or the completed time/duration of an executed script).

Moreover, according to other specific embodiments of the invention, the database administration module 208 includes results logging 246 that is configured to capture results of the deployment/execution of database scripts and store the results in log files. The logged results provide a requisite audit trail for insuring that script updates have been performed. Logged results may on a database server basis 248, a database basis 250 and may include the script sequence/order 252 implemented in the script deployment/execution. Additionally, the database administration module 208 includes report generator 254 that is configured to generate reports associated with script deployment/execution. In specific embodiments the report generator may generate reports that include execution results 256, such results 256 may include segmentation of errors 258 by error type, database server, database or the like. In other embodiments of the invention reports may dynamically be generated on-the-fly by the administrator/user based on user-specific criteria. In other instances, reports may be generated and disseminated to predetermined entities while a script deployment/execution is occurring, such as report that indicates failures/errors in the scripts that prompted an interruption of the execution process

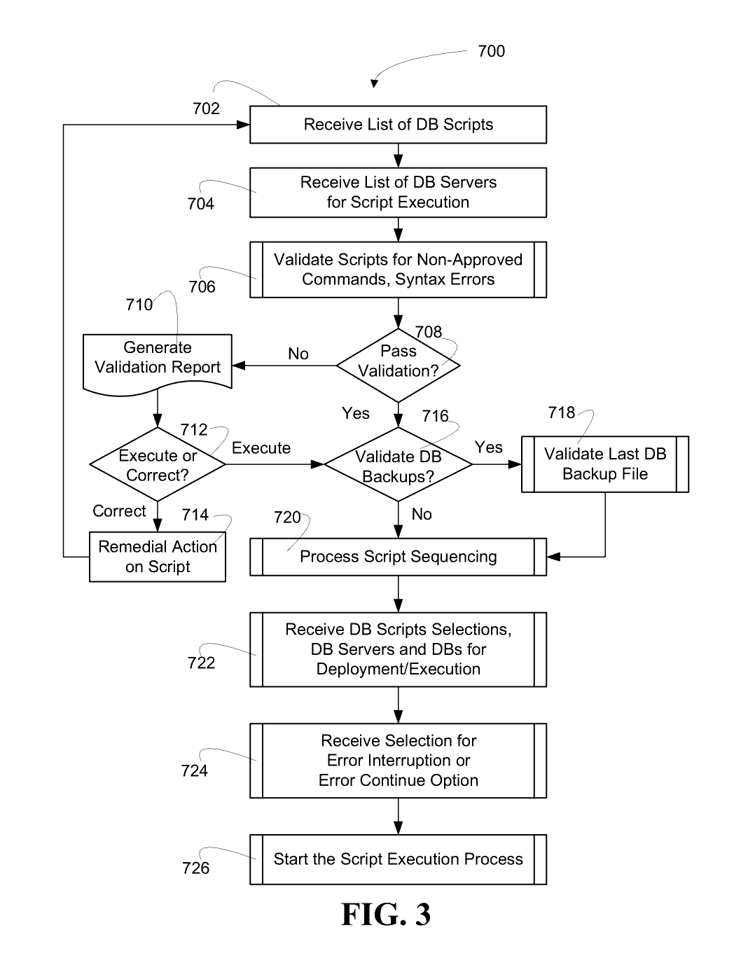

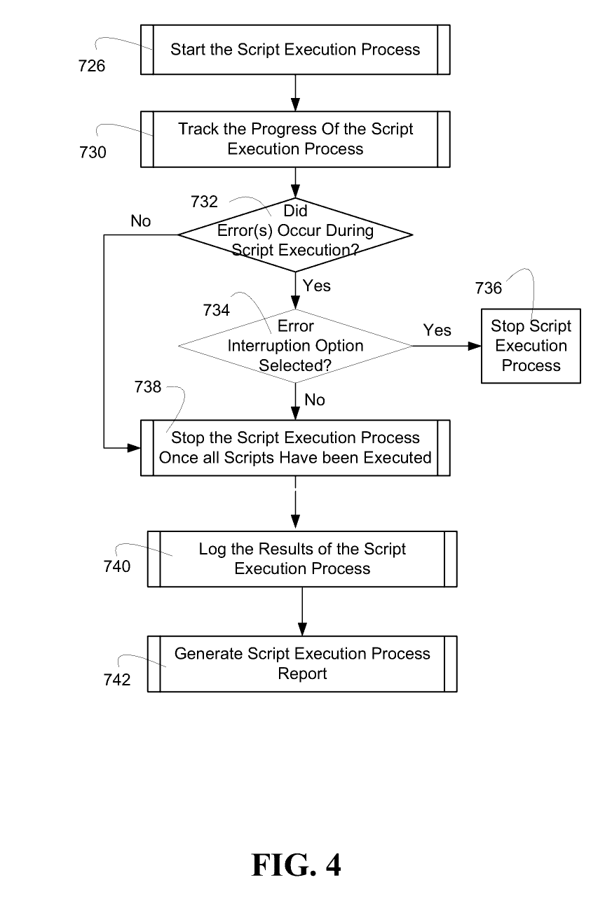

Referring to FIGS. 3 and 4, depicted is a flow diagram of a method 700 for multidimensional database administration, in accordance with embodiments of the invention. At Event 702, a list of database scripts requiring deployment/execution is received and, at Event 704, a list of database servers requiring script deployment/execution is received.

At Process 706. The listed database scripts are validated by determining if the database scripts include non-approved commands. Non-approved commands may be include commands that are excluded for all deployments/executions, as well as, commands that excluded for specific database servers and/or specific databases. At Decision 708, a determination is made as to whether the database scripts have passed validation. If validation results in one or more scripts failing validation, at Event 710, a report is generated and communicated to designated entities within the enterprise, which indicated the non-approved commands and any other validation issues. At Decision 712, a database administrator/user makes a determination as to whether the failed validation (i.e., non-approved commands in the database scripts) warrants corrective action or whether execution can be authorized (i.e., deployment/execution of the scripts can proceed despite the non-approved commands). If corrective action is determined to be warranted, at Event 714, remedial action is performed on the database script(s) having the non-approved commands and, in response to performing the remedial actions (e.g., rewriting the code of the scripts), the method returns to Event 702.

If the database scripts pass validation (Decision 708) or if the determination is made that scripts are authorized to execute (Decision 712), at Decision 716 a decision is made as to whether optional validation of the database backup files is warranted. If a determination is made that database backup file validation is warranted, at Process 718, last-in-time database backup files are validated to insure their integrity prior to processing database script execution. In response to completion of the database backup file validation or a determination that database backup file validation is not warranted, at Process 720, if required, script sequencing/ordering is determined.

In response to completion of the script sequencing process or, if script sequencing is not required for the current script execution, at Process 722, database script selection, database server selection and database selection are received from an administrator/user. As previously noted such selection may include selection of multiple scripts, multiple database servers and multiple databases stored on the selected database servers. At Process 724, an administrator/user input may be received that indicates whether the current execution/deployment of database scripts requires error interruption (i.e., the execution is stopped and the administrator/user is notified when an error in the execution process occurs) or whether the current execution can continue execution, uninterrupted, in the event of an occurrence of an error in the execution process. At Process 726, a user input (e.g., single-click within a GUI interface or the like) is received to initiate the script deployment/execution process.

Referring to FIG. 4, in which the method 700 initiated in FIG. 3 is continued, at Process 730, the progress of the script execution process is tracked, including indicating to the user/administrator the status of ongoing executions, including current duration of scripts being executed, status of completed scripts, including a passed or failed status, indication of errors occurring and the like. At Decision 732 a determination is made as to whether any errors occurred during execution of the database scripts and, if errors did occur, at Decision 734, a determination is made as to whether the error interruption option was selected by the user at Process 724. If the determination is made that the error interruption option was selected by the administrator/user, at Event 736, the script execution process is stopped until the administrator/user can analyze the error and determine whether the error is insignificant or can otherwise be ignored and, thus, execution can be continued or whether the error necessitates aborting further execution. If the determination is made that no errors have occurred during script execution (Decision 732) or the error interruption option was not selected by the administrator/user (Decision 734), at Process 738 the execution continues until all selected database scripts have been executed on all selected database servers and all selected databases. It should be noted that in certain embodiments of the invention, script processing may occur sequentially, such that a first database server is connected to and the databases within the first server that require script update are processed sequentially followed by connecting to a second database server and processing the selected databases within the second database server and so on. In other embodiments of the invention, it may be possible to implement scrip processing in parallel, such that selected database servers are connected to simultaneously and the selected databases within those selected database servers are processed in parallel.

At Process 740, the results of the script execution process are automatically logged. The results that are logged may on a per-database server basis, a per-database basis or the like. In addition, the results may include the sequence/order in which database scripts were executed. The logged results serve as an audit trial for subsequent verification of script execution, investigation or the like.

At Process 742 script execution process reports are generated. Such reports may be preconfigured by the administrator/user for automatic generation and communication to designated parties in response to completion of the script execution process. The administrator/user may define specific information to be included in the reports, such as scripts processed, database servers on which the scripts were deployed, databases on which the scripts were executed, results of the execution including errors encountered, script execution duration and the like. In other embodiments of the invention, the administrator/user may interface with the GUI interface to generate reports on demand, such reports including administrator/user configured information associated with one or more script deployment/execution processes.

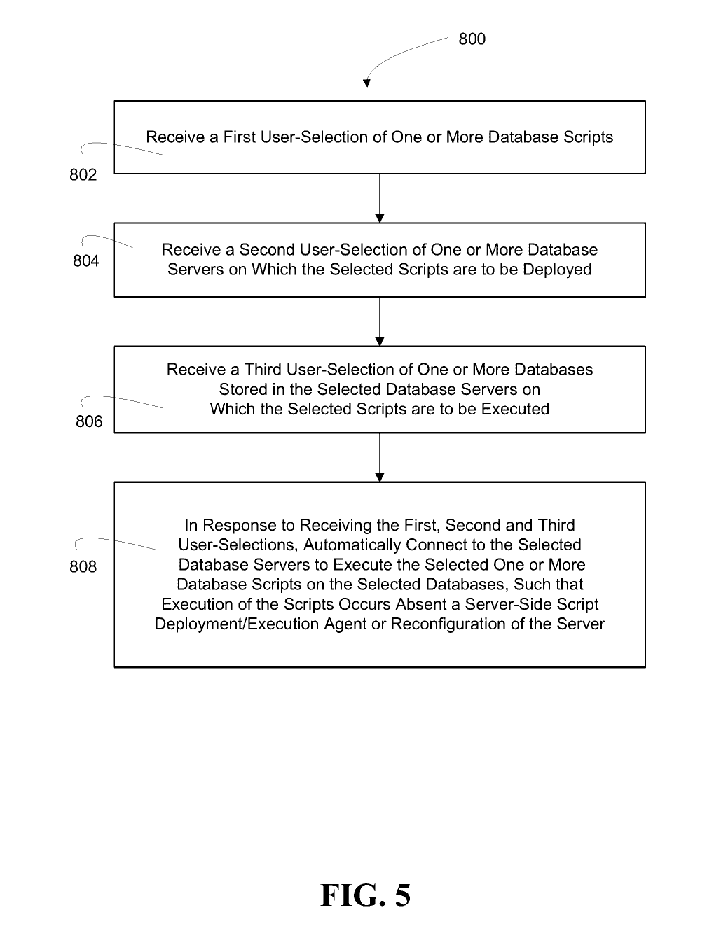

Referring to FIG. 5 a high level flow diagram is provided of a method 800 for multidimensional database administration, in accordance with embodiments of the present invention. The method 800 highlights the multidimensional aspects of the invention, in that multiple database scripts can selected and executed on multiple database servers and multiple databases stored within the database servers. At Event 802, a first user-selection is received of one or more, typically multiple, database scripts that require execution. At Event 804, a second user-selection is received of one or more, typically multiple, database servers on which the selected database scripts are to be deployed. At Event 806, a third user-selection is received of one or more, typically multiple, databases stored on the selected database servers on which the selected scripts are to be executed. It should be noted that the order in which the selections occur is important to the invention herein discussed and, as such, the selections may occur in any order deemed appropriate by the module/application or the administrator/user. Moreover, in certain embodiments of the invention, selection of databases prior to selection of the database servers may obviate the need to receive distinct selections of database servers, since selection of a database would include the database server on which the database is stored. Additionally, in other embodiments of the invention, user-selections of database scripts, database servers and/or databases may not be based on administrator/user selection but may be preconfigured or otherwise received by the system, such as database scripts that are configured to be executed automatically at predetermined times and/or intervals or the like.

At Event 808, in response to receiving the user-selections of the database scripts, database servers and databases and a single input from the administrator/user, automatic connection to the selected servers occur, typically in sequence, to execute the selected scripts on the selected databases. It should be noted that in accordance with embodiments of the invention, execution of the database scripts on the databases servers occurs without having to deploy any server-side agents or software nor perform any reconfiguration of the servers and/or the databases.

Thus, systems, apparatus, methods, and computer program products described above provide for multidimensional automated database administration, such that, multiple database scripts can be deployed and executed across multiple database servers and the multiple databases stored therein. In addition, the present invention manages the sequence/order in which the scripts are automatically deployed/executed and provides for automated tracking of execution results including error tracking on a per script basis. Additionally, the invention herein described in detail below is deployed in a distributed network allowing for cross domain connectivity to the database servers for the purpose of executing the database scripts without requiring deployment of server-side script deployment agents or reconfiguration of the database servers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automated administration of databases, the system comprising:
a plurality of database servers, each database server storing one or more databases;
a computing platform having a memory and at least processor in communication with the memory; and
a database administration module stored in the memory, executable by the processor and configured to be accessible to a user within a distributed network to:
receive a first user-selection of one or more database scripts,
receive a second user-selection of one or more of the database servers on which the selected one or more database scripts are to be deployed,
receive a third user-selection of one or more databases stored in the one or more selected database servers on which the selected one or more database scripts are to be executed, and
in response to receiving the first, second and third user-selections, automatically connect to the selected databases servers to execute the selected one or more database scripts on the selected databases,
wherein the database administration module is configured to execute the database scripts absent a server-side script deployment agent.

2. The system of claim 1, wherein the database administration module is further configured to automatically validate a plurality of database scripts prior to execution of the database scripts, wherein validation of the database scripts includes checking for syntactical errors and non-approved commands within the database scripts for each of the plurality of databases servers and for each of the databases stored on the database servers.

3. The system of claim 2, wherein the database administration module is further configured to, in response to the validation resulting in failure of one or more database scripts, automatically generate a report that includes one or more non-approved commands within the one or more scripts that failed validation.

4. The system of claim 1, wherein the database administration module is further configured to automatically validate one or more database backups prior to execution of the database scripts, wherein validation of the database backups includes checking an integrity of the database backup file and generating a corresponding report.

5. The system of claim 1, wherein the database administration module further comprises a sequence manager configured to automatically manage database script deployment sequence for more than one database script, wherein computer-script deployment sequence is dependent on at least one of the database server and the database on which the more than one database script is to be executed.

6. The system of claim 1, wherein the database administration module is further configured to receive a fourth user-selection, prior to executing the one or more database scripts, that provides for one of (1) execution of the computing scripts to be interrupted in response to detection of an error, or (2) execution of the computing scripts to be uninterrupted in response to detection of an error.

7. The system of claim 1, wherein the database administration module is further configured to automatically track the execution of the selected one or more database scripts on the selected databases of the selected database servers, wherein tracking the execution includes logging (1) the database servers on which the one or more database scripts are executed, (2) the databases on which the one or more database scripts are executed, and (3) sequence in which the one or more database scripts are executed.

8. The system of claim 1, wherein the database administration module is further configured to automatically track the execution of the selected one or more database scripts on the selected databases of the selected database servers, wherein tracking the execution includes identifying database scripts that executed successfully, identifying database scripts that failed to execute successfully and identifying errors occurring on database scripts that failed to execute successfully.

9. The system of claim 1, wherein the database administration module is further configured to, in response completion of the execution of the selected one or more database scripts, generate a report that includes one or more of (i) results of the execution of the selected one or more database scripts, (ii) failure causes for each database script that failed to execute successfully, (iii) segmentation of errors occurring on each database script, and (iv) time of execution for each of the computing scripts.

10. A computer-implemented method for database administration, the method comprising:
receiving, by a computing device processor, a first user-selection of one or more database scripts;
receiving, by a computing device processor, a second user-selection of one or more of the database servers on which the selected one or more database scripts are to be deployed;
receiving, by a computing device processor, a third user-selection of one or more databases stored in the one or more selected database servers on which the selected one or more database scripts are to be executed, and
in response to receiving the first, second and third user-selections, automatically connecting, by a computing device processor, to the selected database servers to execute the selected one or more database scripts on the selected databases,
wherein the database scripts are configured to execute absent a server-side script deployment agent.

11. The method of claim 10, further comprising automatically validating, by a computing device processor, a plurality of database scripts prior to execution of the database scripts, wherein validation of the database scripts includes checking for (i) syntactical errors and (ii) non-approved commands within the database scripts for each of the plurality of databases servers and for each of the databases stored on the database servers.

12. The method of claim 10, further comprising to automatically validating, by a computing device processor, one or more database backups prior to execution of the database scripts, wherein validation of the database backups includes checking an integrity of the database backup file and generating a corresponding report.

13. The method of claim 10, further comprising automatically managing, by a computing device processor, database script deployment sequence for more than one database script, wherein computer-script deployment sequence is dependent on at least one of the database server and the database on which the more than one database script is to be executed.

14. The method of claim 10, further comprising receiving, by a computing device processor, a fourth user-selection, prior to executing the one or more database scripts, that provides for one of (1) execution of the computing scripts to be interrupted in response to detection of an error, or (2) execution of the computing scripts to be uninterrupted in response to detection of an error.

15. The method of claim 10, further comprising automatically tracking, by a computing device processor, the execution of the selected one or more database scripts on the selected databases of the selected database servers, wherein tracking the execution includes logging (1) the database servers on which the one or more database scripts are executed, (2) the databases on which the one or more database scripts are executed, and (3) sequence in which the one or more database scripts are executed.

16. The method of claim 10, further comprising automatically tracking, by a computing device processor, the execution of the selected one or more database scripts on the selected databases of the selected database servers, wherein tracking the execution includes identifying database scripts that executed successfully, identifying database scripts that failed to execute successfully and identifying errors occurring on database scripts that failed to execute successfully.

17. The method of claim 10, further comprising, in response completion of the execution of the selected one or more database scripts, generating, by a computing device processor, a report that includes one or more of (i) results of the execution of the selected one or more database scripts, (ii) failure causes for each database script that failed to execute successfully, (iii) segmentation of errors occurring on each database script, and (iv) time of execution for each of the computing scripts.

18. A computer program product comprising:
a non-transitory computer-readable medium comprising:
a first set of codes for causing a computer to receive a first user-selection of one or more database scripts, a second user-selection of one or more of the database servers on which the selected one or more database scripts are to be deployed and a third user-selection of one or more databases stored in the one or more selected database servers on which the selected one or more database scripts are to be executed, and
a second set of codes for causing a computer to, in response to receiving the first, second and third user-selections, automatically connect to the selected database servers to execute the selected one or more database scripts on the selected databases,
wherein the database scripts are configured to execute absent a server-side script deployment agent.

19. The computer program product of claim 18, wherein the computer-readable medium further comprises a third set of codes for causing a computer to automatically validate a plurality of database scripts prior to execution of the database scripts, wherein validation of the database scripts includes checking for (i) syntactical errors and (ii) non-approved commands within the database scripts for each of the plurality of databases servers and for each of the databases stored on the database servers.

20. The computer program product of claim 18, wherein the computer-readable medium further comprises a third set of codes for causing a computer to automatically manage database script deployment sequence for more than one database script, wherein computer-script deployment sequence is dependent on at least one of the database server and the database on which the more than one database script is to be executed.

21. The computer program product of claim 18, wherein the computer-readable medium further comprises a fourth set of codes for causing a computer to track the execution of the selected one or more database scripts on the selected databases of the selected database servers, wherein tracking the execution includes logging (1) the database servers on which the one or more database scripts are executed, (2) the databases on which the one or more database scripts are executed, and (3) sequence in which the one or more database scripts are executed.
